(19) United States
(12) Patent Application Publication
(10) Pub. No.: US 2024/0018989 A1
(43) Pub. Date: Jan. 18, 2024

(54) MEANS FOR CONNECTION

(71) Applicant: Fraunhofer-Gesellschaft zur Foerderung der angewandten Forschung e.V., Munich (DE)

(72) Inventors: Peter SPIES, Erlangen (DE); Johannes WIECZOREK, Erlangen (DE); Markus POLLAK, Erlangen (DE); Johannes WORM, Erlangen (DE); Ferdinand KEMETH, Erlangen (DE); Marcel PLOGMEYER, Braunschweig (DE); Saskia Nina BIEHL, Darmstadt (DE); Anja GEMEINHARDT, Erlangen (DE); Alexej JARRESCH, Erlangen (DE); Tobias DRÄGER, Erlangen (DE)

(21) Appl. No.: 18/174,315

(22) Filed: Feb. 24, 2023

Related U.S. Application Data
(63) Continuation of application No. PCT/EP2021/073626, filed on Aug. 26, 2021.

(30) Foreign Application Priority Data
Aug. 27, 2020 (DE) 102020210859.5
Oct. 2, 2020 (EP) 20199898.6

(51) Int. Cl. F16B 31/02

(52) U.S. Cl. CPC F16B 31/028; F16B 2200/93

(57) ABSTRACT

A connection device, in particular a screw connection device, including: an energy supply device; a communication device, and a sensor system, wherein the energy supply device is configured to supply the sensor system and/or the communication device with energy, wherein the communication device is configured to transfer a sensor value with the aid of the sensor system to the outside.

### CROSS-REFERENCES TO RELATED APPLICATIONS

This application is a continuation of copending International Application No. PCT/EP2021/073626, filed Aug. 26, 2021, which is incorporated herein by reference in its entirety, and additionally claims priority from German Application No. 10 2020 210 859.5, filed Aug. 27, 2020, and European Application No. EP 20 199 898.6, filed Oct. 2, 2020, all of which are incorporated herein by reference in their entirety.

### BACKGROUND OF THE INVENTION

Embodiments of the present invention relate to a means for connection such as, in particular, a means for screw connection. Further embodiments relate to a two-part means for connection, e.g. including a screw and a washer. According to advantageous embodiments, the means for connection includes a sensor system or an electronic system in general.

The integration of electronic systems into mechanical components, such as means for connection, is often problematic since installation space typically required to achieve mechanical stability has to be kept free for the integration. Externally providing electronic components creates the problem that ease of assembly is no longer given. Energy supply, which is usually carried out via an external wiring, creates an additional problem, since it may also entail conflicts with respect to the ease of assembly. Thus, there is the need for an improved approach.

### SUMMARY

An embodiment may have a screw connection system with at least two individual elements, namely a connection device, in particular a screw connection device, as a first element, and a washer as a second element, comprising: an energy supply device; a communication device; and a sensor system, wherein the energy supply device is configured to supply the sensor system and/or the communication device with energy, wherein the communication device is configured to transfer a sensor value that is determined with the aid of the sensor system to the outside; wherein the washer comprises at least two elements; wherein a sensor layer system or a sensor layer or a Diaforce layer is provided as part of the sensor system between the two elements of the washer.

Embodiments of the present invention provide a means for screw connection (or screw connection assembly or screw connection device), or a screw connection system, with means for energy supply (or energy supply assembly or energy supply device), means for communication (or communication assembly or communication device), such as means for long-range communication, and a sensor system. The means for energy supply is configured to provide the sensor system and/or the means for communication with energy. The means for communication is configured to transfer a sensor value determined with the aid of the sensor system to the outside.

According to advantageous embodiments, the means for connection (or connection assembly or connection device), or the means for screw connection, is configured in the form of a screw connection element with all the stated components. According to a further advantageous embodiment, the means for screw connection is configured as a screw connection system with at least two individual elements, such as a screw and a washer. For example, the sensor system may be a force sensor system.

Embodiments of the present invention are based on the finding that an electronic system may be easily integrated into a screw or into elements connected to the screw, such as a washer, or into components of the means for connection in general, e.g. into a cavity in the screw shank or the screw head. This system may comprise an integrated sensor system that transfers the sensor data to the outside by using means of communication. The integration into means for screw connection is advantageous because they are used in different applications so that the integration of an electronic system into mechanical systems would be possible without a new design of the same.

A washer comprises an essentially round or rotation-symmetrical shape and does not laterally extend beyond the screw head or only beyond a limited area.

As indicated above, the means for screw connection (or screw connection assembly or screw connection device) may be available as a screw connection system having a screw or a nut as a first element and a washer as a second element. The sensor system, such as the force sensor system, may then be integrated into the washer, wherein the other elements, such as the means for energy supply or the means for communication, are integrated into the screw or the nut. For example, the tight fit of the screw connection may be sensed by means of the sensor system, or the force sensor system. According to embodiments, in case of a washer configured as a force sensor system, one can assume that this washer itself comprises two elements between which the sensor system is integrated. This is advantageous since it enables preventing damaging of the sensor layer system (e.g. including a sensor layer or a Diaforce layer) through the torsional movement during fastening. According to embodiments, the sensor system is connected to the energy supply and/or the means for communication via a cable. According to embodiments, the cable connection may be provided between the screw and the washer in a kind of recess or concentric recess. The recess, or concentric recess, is advantageously integrated into the washer, that is, on the side facing the screw or the nut. This prevents squeezing/crushing. In addition, according to further embodiments, the screw or the nut and/or the washer comprises on a side facing the respectively other element a carrier configured to limit torsion of the screw or the nut relative to the washer. This also enables a protection of the cable connection. According to alternative embodiments, conductive or capacitive coupling would be conceivable. It would also be conceivable that another contact connection is configured.

With respect to the means for energy supply, it is to be noted that it may comprise an energy harvester, for example, such as a thermal energy harvester, a solar cell as an energy harvester, or a vibration transducer as an energy harvester. With respect to the means for communication, it is to be noted that it may be configured as a means for long-range communication, such as Wi-Fi or long-range Bluetooth. In addition, the screw may also comprise means for near-field communication operable without energy supply by the means for energy supply, in contrast to the means for long-range communication. RFID exemplarily represents this means for near-field communication. At this point, it is to be noted that, according to embodiments, the means for long-range communication and the means for near-field communication communicate in an identical or at least partially overlapping or non-overlapping frequency range as the means for communication, or the means for long-range communication. The overlapping, or partially overlapping, frequency range is advantageous since it enables to access a common antenna. Furthermore, the RFID signals could be used as wake-up signals for the other radio chip.

As explained above, the electronic components, such as means for energy supply and/or means for communication, are arranged in a type of recess, such as a milled-out portion of the screw or the screw shank.

According to embodiments, the sensor system includes a temperature sensor system or a force sensor system, or a further sensor system. In addition, according to embodiments, there may be a processor that is connected to the sensor system and is configured to determine the sensor value in a digital or analog way. For example, determination could be read out on the basis of a frequency that varies across a resistor as a frequency-determining element. A resistance from the frequency-determining element may be used to measure temperature, since the resistance behaves in a temperature-dependent way, or also to measure force, e.g. assuming strain gauges (varied impedance) or piezo-elements. For example, the processor is arranged together with the means for energy supply and/or the means for communication and reads out the sensor value with respect to the processor, or the means for energy supply, or the means for communication of the externally arranged sensor. Thus, for example, the entire intelligence is arranged in the screw, or the screw head or the nut.

A further embodiment provides a means for connection with a screw, wherein a cooling body is provided as part of the screw head.

### BRIEF DESCRIPTION OF THE DRAWINGS

Embodiments of the present invention will be detailed subsequently referring to the appended drawings, in which:

FIG. 1 shows a schematic illustration of a means for connection, in particular a means for screw connection, according to a base embodiment;

FIG. 2a shows a schematic illustration of a screw as part of the means for connection according to extended embodiments;

FIG. 2b shows a schematic illustration of an electronic measuring system for the means for connection according to extended embodiments;

FIG. 2c shows a schematic illustration of a washer with an integrated sensor system according to extended embodiments.

### DETAILED DESCRIPTION OF THE INVENTION

Before explaining embodiments of the present invention on the basis of the accompanying drawings, it is to be noted that elements and structures having the same effect are provided with the same reference numerals so that their description can be applied to each other.

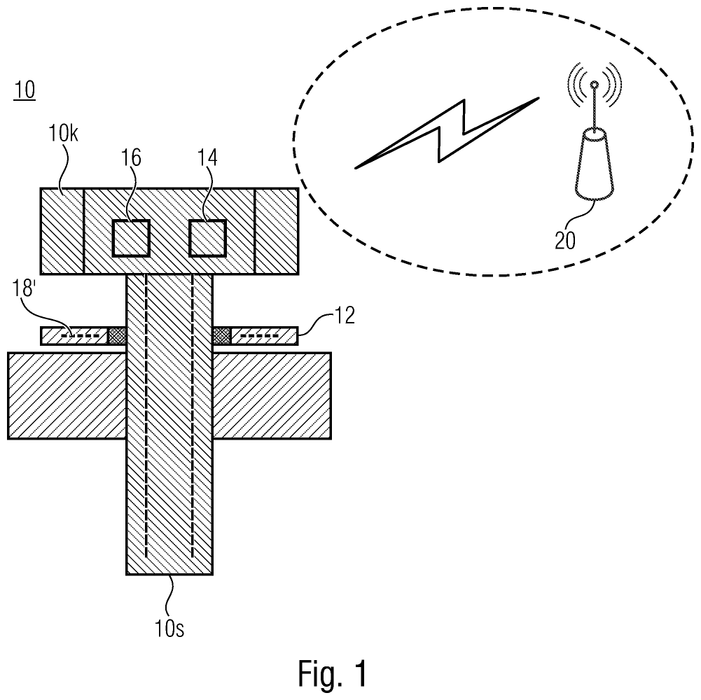

FIG. 1 shows a means for connection 10 (or connection assembly or connection device), here in the form of a screw with a screw head 10k and a screw shank 10s. The means for connection 10 further includes a washer 12 that is plugged onto the screw shank 10s and that can be brought into contact with the bottom side of the screw head 10k (the side towards the shank 10s).

In this embodiment, the means for connection is configured to be in two parts, wherein this is optional, and a one-part configuration would also be conceivable according to further embodiments.

The screws 10k+10s include an electronic system, e.g., that may include means for communication 14 as well as means for energy supply 16. For example, the means for communication may include a means for long-range communication (Bluetooth, Bluetooth-long range, UWIN, etc.) and is configured to transfer information, such as information obtained with a sensor system, to the outside. It would also be conceivable to transfer stored information, such as position information or an ID, to the outside. According to a further variation, it would also be conceivable to use so-called means for near-field communication (cf. RFID). The means for near field communication is to be understood as an alternative or an addition. The current supply unit 16 is used for supplying current to the means for communication 14.

For example, the current supply unit 16 may store energy, e.g. by using a battery, energy harvesters, e.g. a temperature harvester or vibration harvester, or control an energy flow, e.g. if external energy for operating the means for communication 14 is provided via a means for near-field communication through a transmission alternating field. According to embodiments, the energy supply circuit is provided with an energy harvester, with an energy storage, with a rectifier, and/or with voltage transducers. Alternative harvesting variations, e.g., on the basis of photovoltaics or solar heat, would be conceivable.

At this point, it is to be noted that, according to embodiments, the means for energy supply 16 may not only provide the means for radio communication 14 with energy, but also additional means, such as an external sensor system, or an internal sensor system. In this embodiment illustrated in FIG. 1, the washer 12 comprises a sensor system 18, here in the form of a Diaforce layer. For example, the Diaforce layer 18 is configured to perform static and dynamic force measurements. For example, a force between the first main surface and the second main surface would be detectable, which enables a conclusion as to the fit of the screw connection. Obviously, other (i.e. alternative or additional) physical quantities to be measured, such as a temperature, would be determinable. According to embodiments, the sensor system 18 is connected to the electronic systems 14 and 16 and, possibly to an optional processor (not illustrated). Cable connections, capacitive connections, inductive connections, or simple contact connections, are used as connections.

By using the means for radio communication 14, the sensor data determined by means of the sensor system 18 may be transferred to the outside. For example, when assuming UWIN or MIOTY LP-WAN as a radio standard, this sensor data may be transferred to an external base station 20. The means for energy supply 16 provides the required energy. In case of MIOTY LP-WAN, the energy needs are limited since this standard enables a very energy-efficient and simultaneously reliable data transfer. According to an advantageous variation, the antenna of the means for radio communication 14 are arranged in the screw head 10k so as to be able to be well adapted to the metal environment. An alternative adaption would be conceivable. According to further embodiments, the means for radio communication may alternatively or additionally use means for near-field radio communication, such as RFID. They do not require an integrated active current supply, but are usually based on the components (sensor system, processor, and means for radio communication 14) being momentarily provided with energy by means of a current supply circuit 16. RFID enables the read-out of current sensor data, an individual configuration of the system 10, as well as an identification of the system 10, e.g. if an ID is stored in the means for radio communication 14. Information, e.g. about the state of the screw connection, could then be displayed through a means of illumination, e.g. an LED.

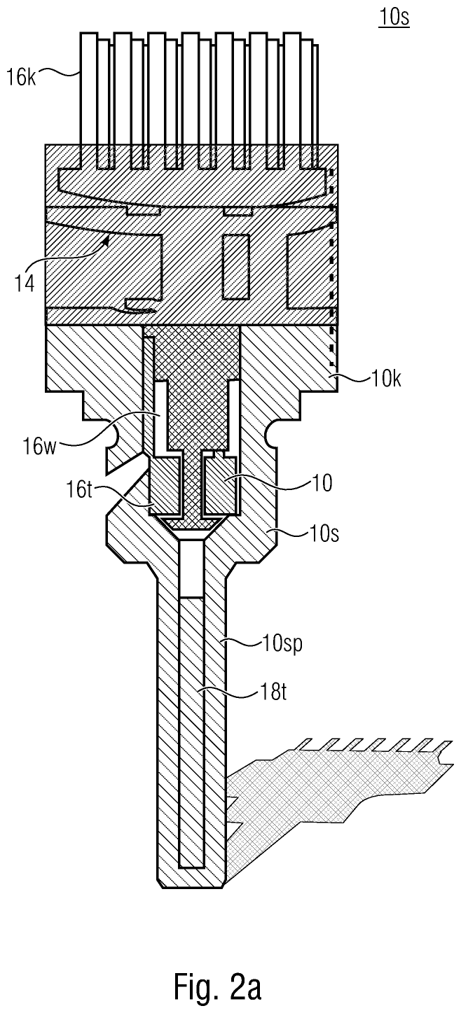

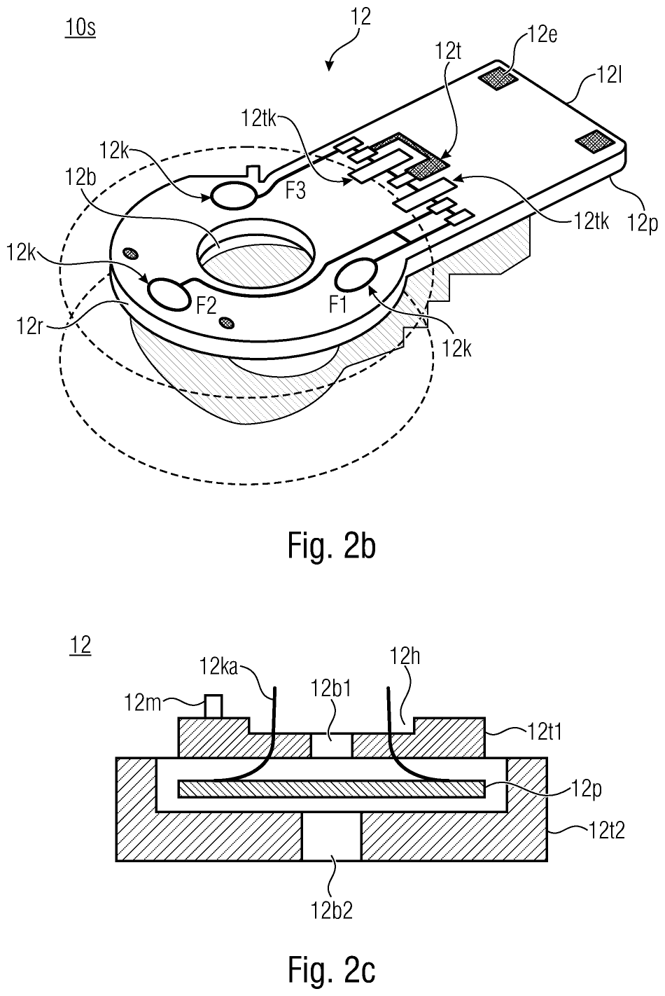

Advantageously, this means for connection 10 provides a maintenance-free robust sensor system to cognitively monitor, or remotely monitor, security-critical mechanical connections and complex structures. Applications are any screw connections, e.g. on structures, production equipment, wind generators, machine parts, etc. With reference to FIG. 2a, a screw as part of the connection is explained.

FIG. 2a shows a screw 10s with a screw head 10k, a screw shank 10s, and an optional screw tip 10sp. A thermal generator 16t as an energy harvester is provided in a recess 10a of the screw that extends in the screw shaft 10s and/or the screw tip 10sp. A thermal generator is connected to a heat conducting element 16w with a cooling body 16k.

In addition, the screw comprises an electronic system 14 having integrated therein the means for radio communication. In this embodiment, the electronic system is arranged on the screw head 10k as a type of extension, or between the cooling body 16k and the actual screw head 10k. In this embodiment, the sensor system may either be arranged as a temperature sensor system 18t in the screw tip 10sp or also externally, e.g. in a washer 12 (cf. FIG. 2b). Cables for coupling the external sensor system may be provided in the contact area between the screw head 10k and the washer 12.

At this point, it is to be noted that most features are optional in this embodiment so that, according to other embodiments, other types of energy harvesters without a cooling body 16k, heat bridge 16w and thermal element 16t may be used. The temperature sensor 18t and the elongated tip 16sp are optional as well. With respect to the electronic system, it is to be noted that it is advantageously embedded or enclosed, e.g. by means of a casting compound, as is illustrated on the basis of the dotted lines associated with the screw head 10k.

FIG. 2b shows a variation of a washer 12, or in particular of the electronic system of the washer 12 provided on a board 12b. For example, the board 12b comprises a round area 12r and an elongated cantilever. A drill hole 12b for the screw shank 12s is provided in the round area 12r. This includes a board 12p with one or several force measurement elements 12k. Here, three force-measuring elements 12k are arranged, e.g., which may be provided as strain gauges or as Diaforce elements. The force measuring elements 12k tangentially extend in the round area 12r around the drill hole 12b.

Optionally, the washer 12, or the sensor of the washer 12, may also comprise a temperature sensor system 12t in addition to the force sensor system 12k. For example, the same consists of a resistor structure. Beside sensing the temperature, the sense and purpose of this temperature sensor system is also the possibility to carry out temperature 35 compensation, e.g. of the force measurement values. A corresponding temperature compensation circuit 12tk is illustrated next to the temperature sensor 12t, with conductor paths to the force sensors 12k also being illustrated.

According to further embodiments, the board 12p comprises one or several electrical contacts 12e that make it possible to be contacted from the outside, e.g. from the electronic system 14 of the screw 12s.

This system, consisting of the screw 10s and the washer 12, makes it possible to read out and transfer to the outside the force sensor values of the force sensors 12k via the electronic system 14.

There are different variations with respect to the read-out modalities. A type of AD transducer may be integrated into the electronic system 14 or the electronic system of the washer 12 so that the analog signal that depends on the physical measurement quantity may be digitalized and transferred. Alternatively, it would also be conceivable that the sensor system 12k, or 12t, is configured as a frequency-determining element. For example, resistors may be used that form a corresponding resistance, or impedance, value as a function of the acting force or as a function of the surrounding temperature, wherein a signal varying in frequency may be sensed via frequency excitement, wherein the resulting frequency offers a conclusion as to the physical measurement quantity.

With respect to FIG. 2c, a washer 12 with all its components is now described. The washer 12 includes two parts 12t1 and 12t2. A board 12p with a corresponding sensor electronic system (not illustrated) is introduced between these parts 12t1 and 12t2. For example, the lower part 12t2 may comprise a recess for the board 12p. The upper part 12t1, for example, is embedded into this recess and therefore closes the inside of the washer 12. The corresponding drill holes are marked with 12b1 and 12b2 for both parts 12t1 and 12t2. In this embodiment, one can assume that the parts 12t1 and 12t2 extend concentrically with respect to each other and/or radially symmetrical around the drill axis. According to embodiments, a steel sheet for guiding the flux of force may be provided between the two elements/discs. Thus, the washer includes at least two elements.

According to embodiments, the upper part 12t1 comprises a notch 12n or milled-out portion on a side directed towards the outside, i.e. on the side facing the screw, or the screw head 10k (see FIG. 1a or 2a). It is the purpose of this notch to protect the cables 12ka extending out of the board 12p in case of contact of the screw head 10k with the surface of the part 12t1. According to embodiments, this notch 12n may also be part of the screw head 10k. According to further embodiments, the washer 12, or the part 12t1, may comprise a type of carrier 12m configured to interact with a type of carrier of the screw (not illustrated) and to therefore prevent, or at least limit, torsion between the washer 12 and the screw so as to protect the cables 12ka.

Even though the above embodiments assume that the electronic system including the means for energy supply and radio communication are arranged in a screw or in the screw head, it is to be noted at this point that an arrangement in a nut, such as a cap nut, or the like would be conceivable.

Subsequently, optional aspects of the screw, in particular a screw with a thermal generator as an energy harvester, are explained.

According to an additional aspect, a means for connection is provided, such as a screw with a means for energy supply in the form of at least one thermal element, wherein the at least one thermal element is introduced into the means for connection/the screw or into a shank.

A means for energy supply in the form of thermal elements enables the use of a temperature difference to generate a current. Due to the fact that a screw (a means for connection in general) has a certain length, a temperature difference between the screw head and the screw tip may be employed. Higher temperature differences may be created through the use of a cooling body that is thermally decoupled from the screw, and they may be used by means of energy harvesting. Thus, additional aspects of the present invention are based on the finding that, through (vertical) integration of thermal elements into a screw, there is the possibility to harvest energy, even if the screw is fixed at locations that do not have sufficient movement, vibration or the like, to enable other energy harvester methods. Advantageously, by means of such an energy harvester, an entire sensor system, evaluation electronic system or radio transfer of a measurement system may be supplied with electrical energy. For example, these elements may be integrated into the screw or in the screw head, or may be attached to the screw or the screw head. Through this, cables and batteries may be omitted, which simplifies installation and maintenance and saves costs. In some applications, the use of cables may be impossible since the sensors are arranged in an object that rotates quickly so that a compact integrated system is desired here. Batteries cannot be used everywhere since they cannot be used due to high temperatures.

At this point, it is to be noted that bolts or similar (elongated) elements may be used beside screws as a means for connection. Since screws represent the advantageous embodiments, the optional features are explained in connection with screws even though the features can be transferred to all types of means for connection, such as bolts.

In the proposed structure, the particular advantage is in the vertical arrangement of the thermal generators in the screw. In case of a cold start of the system, the required temperature difference is achieved significantly earlier at this location. Thus, the system is ready more quickly, and the time in which critical events may be missed is reduced. Assuming that the screw tip is arranged very close to the heat source, or the heat sink, the temperature difference and the energy to be harvested therewith may be maximized. The temperature difference may be increased further, e.g. by introducing a cooling body as a heat sink. According to further embodiments, this cooling body may also serve as a heat source, e.g. if there is external radiation. According to the embodiments, the cooling body is placed onto the screw head and is therefore higher. The effect is amplified in case of a large heat flow to the surrounding medium, e.g. in case of a higher wind speed.

According to the additional aspects, the screw may comprise a shank, wherein the thermal element is introduced into the screw or the shank. To this end, according to the additional aspects, a drill hole may be provided. The vertical arrangement makes it possible to use more surface area for the thermal generators (e.g. to the interior wall of the drill hole). Thus, the entire system is also suited for smaller screw diameters. According to an additional aspect, the above described drill hole may be a conical drill hole. This oblique arrangement makes sense from a mechanical point of view. Through this, a greater fitting pressure for the thermal generators against the screw wall, or heat bridge, may be realized. Air connections are avoided and the thermal resistance to the heat source, or heat sink, is reduced. Thus, the screw provides more electrical power. In addition, the construction is significantly simpler and more reproducible. These advantages are amplified if the thermal generator is soldered to a side, according to further additional aspects.

According to additional aspects, a heat bridge is provided between the thermal element (in the base of the screw), in the screw head, or the cooling body. For example, this heat bridge may be insulated with respect to the screw or the screw shank. Soldering (cf. above) may be provided between a heat bridge and the thermal generator.

According to an additional aspect, the thermal element may be configured to have an annular shape. This may be realized, among other things, by means of flat flexible thermal generators. A further increase in size of the contact surfaces is achieved by the use of such annular thermal generators.

As explained above in the context of the advantages, an electronic system may be integrated into the screw. In this case, according to the additional aspects, it would be conceivable that the electronic system may also comprise a processor for a sensor system, the sensor system itself, and/or a means for communication. According to further additional aspects, the electronic system may also comprise an energy storage. This energy storage is used for buffering the electrical energy. It is to be noted that the electronic system may be arranged between the screw head and the cooling body, for example. The cooling body may be connected to the thermal element by means of an optional heat bridge, wherein, e.g., the heat bridge extends through a drill hole in the electronic system.

According to the additional aspects, e.g., the sensor system may include a temperature sensor, it may be provided in the foot of the screw.

According to a further additional aspect, it would also be conceivable for the screw to comprise a solar cell. The background for this is that, in particular, energy harvesting with the thermal generator is carried out in case of a temperature difference. For example, this temperature difference may be caused by the fact that the external temperature increases as a consequence of solar irradiation in contrast to the temperature of the screw tip, or when this radiation does not take place, the screw head, or cooling body, cools down faster. In the time span in which sunlight strikes the screw, but the screw head and the screw tip have similar temperatures, the efficiency of the energy harvesting with the thermal element is limited. Additional energy may be generated in this case with the solar cell.

According to the additional aspects, the screw head and the cooling body may be integrated or combined. Use of the screw head and a cooling body enables a larger cooling surface area at the same size of the screw structure. This increases the power density of the module compared to a separate configuration of the screw head and the screw cooling body.

According to the additional aspects, accordingly, the screw head is the heat source or heat sink and the screw tip is the corresponding counter-piece. According to the additional aspects, this may depend on the time, or the surroundings.

According to the additional aspects, one can assume that the cooling body and the heat bridge are two parts. A two-part configuration of the cooling body and the heat bridge enables to use as many surfaces or surface areas for the electronic system, or battery, as possible since they may be introduced from the top side. However, better thermal behavior is created if the element's cooling body and heat bridge are configured as an integrated component.

By using a standard part for the outside geometry of the screw, the subsequent integration of the measurement system in already existing applications is simplified. The measurement system may also be replaced with an available measurement system that uses the same standard parts without having to perform changes on the rest of the structure. By using a screw or a profile that is attached in a clamped way, good thermal contact to the heat source/sink is provided.

At this point, it is to be noted that the above embodiments are only illustrative and that the protective scope is defined by the subsequent claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

LIST OF REFERNCE NUMERALS

| | |
|---|---|
| Means for screw connection (10) | Screw (10s) |
| Sensor system (18, 12k, 12tk) | Means for communication (14) |
| Means for energy supply (16) | Screw connection element (10s) |
| Washer (12) | Recess (12n) |
| Carrier (12m) | Cable (12ka) |
| Energy harvester (16t) | Screw head (10k) |
| Screw shank (10s) | |

1. Screw connection system with at least two individual elements, namely a connection device, in particular a screw connection device, as a first element, and a washer as a second element, comprising:
an energy supply device;
a communication device;
and a sensor system,
wherein the energy supply device is configured to supply the sensor system and/or the communication device with energy,
wherein the communication device is configured to transfer a sensor value that is determined with the aid of the sensor system to the outside;
wherein the washer comprises at least two elements;
wherein a sensor layer system or a sensor layer or a Diaforce layer is provided as part of the sensor system between the two elements of the washer.

2. Screw connection system according to claim 1, wherein a screw or a nut forms the first element.

3. Screw connection system according to claim 1, wherein the energy supply device and the communication device are integrated into the screw or into the nut.

4. Screw connection system according to claim 1, wherein the sensor system is integrated into the washer.

5. Screw connection system according to claim 1, wherein the two elements extend concentrically with respect to each other and/or extend radially symmetrically around a drill axis.

6. Screw connection system according to claim 1, wherein one of the two elements of the washer comprises a recess or concentric recess on the side facing the screw or the nut.

7. Screw connection system according to claim 3, wherein the screw or the nut and/or the washer comprises carriers arranged on a side facing the respectively other element and configured to limit torsion of the screw or the nut with respect to the washer.

8. Screw connection system according claim 7, wherein the sensor system is connected to the energy supply and/or the communication device via cables, and wherein the cable connection extends in the recess.

9. Screw connection system according to claim 7, wherein the sensor system is connected to the energy supply device and/or the communication device via a cable connection or an electrical contact.

10. Screw connection system according to claim 1, wherein the sensor system is inductively or capacitively connected to the energy supply device and/or the communication device.

11. Screw connection system according to claim 1, wherein the energy supply device comprises an energy harvester, a thermal energy harvester, a solar cell as an energy harvester, and/or a vibration transducer as an energy harvester.

12. Screw connection system according to claim 1, wherein the communication device comprises a long-range communication device, in particular Wi-Fi or long-range Bluetooth.

13. Screw connection system according to claim 1, wherein the screw connection device comprises near-field communication device, wherein the near-field communication device is configured to perform near-field communication without energy supply by the energy supply device; and/or
wherein the screw connection device comprises near-field communication device, wherein the near-field communication device is configured to perform near-field communication without energy supply by the energy supply device, and wherein the near-field communication device is configured to communicate in an identical or at least partially overlapping or non-overlapping frequency band as the communication device.

14. Screw connection system according to claim 1, wherein the screw connection device comprises at least one screw, wherein the screw comprises a recess in the screw head and/or a milled-out portion in the shank, and wherein the energy supply device and/or the communication device is arranged in the one or several recesses.

15. Screw connection system according to claim 1, wherein the sensor system comprises a temperature sensor system, a force sensor system, or a further sensor system; and/or
wherein the sensor system is connected to a processor configured to read out the sensor value in a digital or analog manner or on the basis of a frequency that is varied across a resistor as a frequency-determining element; and/or
wherein the sensor system is connected to a processor and wherein the processor is arranged together with the energy supply device and/or the communication device, and wherein the processor is configured to read out the sensor value.

16. Screw connection system according to claim 1, wherein the connection device comprises a screw, and wherein a cooling body is provided as part of the screw head.
